(19) United States
(12) Patent Application Publication
(10) Pub. No.: US 2026/0252672 A1
(43) Pub. Date: Aug. 27, 2026

(54) SECURITY PARAMETER FOR A SERVICE REQUEST

(71) Applicant: Motorola Mobility LLC, Chicago, IL (US)

(72) Inventors: Amit Kumar Agrawal, Bangalore (IN); Vijayprakash Idlur, Bangalore (IN); Hariprasad Shanbhogue Alampady, Bengaluru (IN)

(73) Assignee: Motorola Mobility LLC, Chicago, IL (US)

(21) Appl. No.: 19/065,667

(22) Filed: Feb. 27, 2025

(51) Int. Cl. G06F 21/31; H04L 9/40

(52) U.S. Cl. CPC G06F 21/31; H04L 63/107

(57) ABSTRACT

Techniques for security parameter for a service request are described and are implementable to enable user security parameters (e.g., security states) to be considered for service requests. For example, a client device (e.g., a mobile device such as a mobile phone) receives an indication of a service request and determines, based at least in part on sensor data, user state data associated with a user associated with the service request. The client device determines a user security parameter based at least in part on the user state data, and processes the service request based at least in part on the user security parameter and one or more service security statuses for one or more service providers available to provision a service for the service request.

### BACKGROUND

The use of digitally accessible service providers enables users to access a wide variety of different services and products via digital interactions, e.g., via mobile devices such as mobile phones. For instance, users can access different services on demand, such as transportation, product delivery, home services, etc. While the availability of digitally accessible service providers can provide a great deal of convenience, it is not without risks. For instance, some service providers may provide users with unsafe service scenarios and/or service scenarios that result in a poor user experience due to unsatisfactory service conditions.

### BRIEF DESCRIPTION OF THE DRAWINGS

Aspects of security parameter for a service request are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of security parameter for a service request can be implemented.

FIG. 2 illustrates an example flow chart for a process in accordance with aspects of the present disclosure.

FIG. 3 illustrates a flow chart depicting an example method for security parameter for a service request in accordance with one or more implementations.

FIG. 4 illustrates a flow chart depicting an example method for security parameter for a service request in accordance with one or more implementations.

FIG. 5 illustrates various components of an example device in which aspects of security parameter for a service request can be implemented.

### DETAILED DESCRIPTION

Techniques for security parameter for a service request are described and are implementable to utilize user state data to determine a user security parameter, and identity service providers with a security status that complies with the user security parameter.

For example, consider a scenario in which a user requests a service, such by utilizing a mobile device to request transportation from a current user location to a specified destination. In association with the service request, user state data can be aggregated to determine a user security parameter of the user, e.g., a user security state. The user state data can include a location (e.g., physical location) of the user, trusted devices and/or trusted persons in proximity to the user, a time of day, etc. Based at least in part on the user state data, a user security parameter can be determined, such as whether the user is in a high security state, a medium security state, or a low security state.

Further, based at least in part on the user security parameter, a system (e.g., the mobile device, a network security service) attempts to identify a service provider with a security status that complies with the user security parameter. Different service providers, for example, may have different security statuses, such as based on known security-related attributes of the service providers, past user feedback (e.g., user reviews and/or ratings) regarding the service providers, etc. If a service provider is identified with a security status that complies with the user security parameter, the service request can be communicated to the service provider. If a service provider with a security status that complies with the user security parameter is not identified, the user can be notified that no compliant service providers are identified. In at least one implementation, an override option can be provided such that the user can request the service from a service provider with a security status that does not comply with the user security parameter.

Accordingly, techniques for security parameter for a service request can be implemented to protect user safety and thus provide increased personal security, such as in potentially unsafe scenarios. Further, system resources that may be used to attempt to locate a safe service provider (e.g., processor resources, memory resources, network resources) can be conserved, such as by avoiding repeated attempts to locate a service provider that complies with user security parameters.

While features and concepts of security parameter for a service request can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

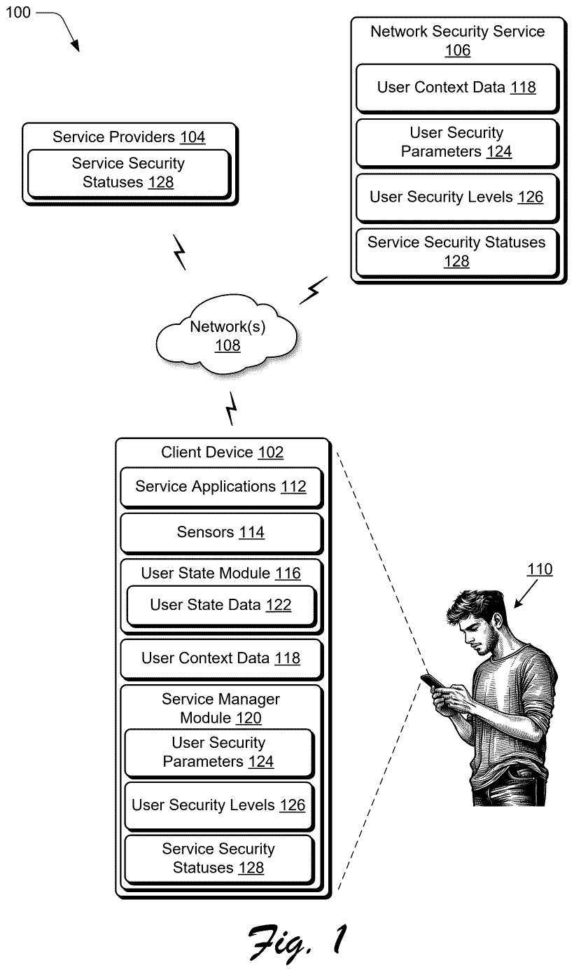

FIG. 1 illustrates an example environment 100 in which aspects of security parameter for a service request can be implemented. The environment 100 includes a client device 102, service providers 104, a network security service 106, and one or more network(s) 108. The client device 102 represents a device that can be used by a user 110 to perform different tasks, such as service requests. The client device 102 can be implemented in various ways, such as a mobile device (e.g., mobile phone, wearable device, tablet device, etc.), a laptop computer, a desktop computer, etc. The service providers 104 represent entities (e.g., network accessible services) that can provide different services to the user 110. The network security service 106 represents a network-based service that can communicate with the client device 102 and the service providers 104 (e.g., via the network(s) 108) to perform and/or assist with various operations pertaining to security parameter for a service request described herein.

The client device 102 includes functionality that is operable in association with techniques for security parameter for a service request described herein including service applications 112, sensors 114, a user state module 116, user context data 118, and a service manager module 120. The service applications 112 represent functionality for requesting various services for a user, such as the user 110. Examples of services that can be requested via the service applications 112 include transportation, product delivery, home services (e.g., house cleaning, home repair), etc.

The sensors 114 are representative of functionality to detect various physical and/or logical phenomena in relation to the client device 102, such as motion, light, image detection and recognition, time and date, position, location, touch detection, sound (e.g., voice), temperature, and so forth. Examples of the sensors 114 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. The sensors 114, however, can include a variety of other sensor types in accordance with the implementations discussed herein.

The user state module 116 is representative of functionality to monitor and detect different user states in relation to the client device 102, such as user states associated with the user 110. For instance, the sensors 114 can generate sensor data that can be utilized by the user state module 116 to monitor user states of the user 110. As further detailed below, for example, the user state module 116 can utilize sensor data to generate user state data 122 that describes various user state attributes of the user 110.

The user context data 118 represents data that is usable by the service applications 112 and/or the service manager module 120 to manage service-related operations. Examples of the user context data 118 include user feedback data for one or more previous service provisions associated with the user, user preference data, service history data for one or more previous service provisions associated with the user, etc.

The service manager module 120 represents functionality for managing different services requested by and/or provided to a user of the client device 102, e.g., the user 110. The service manager module 120, for example, can interact with and/or manage the service applications 112, such as further to techniques for security parameter for a service request described herein. The service manager module 120 maintains and/or has access to user security parameters 124, user security levels 126, and service security statuses 128. The user security parameters 124 represent data that indicates different security attributes of a user, such as specified personal security conditions of the user 110 that are predefined. The user security levels 126 represent security classifications for a user, such as a security states at a particular time. In implementations, the service manager module 120 can determine the user security levels 126 based at least in part on the user state data 122, the user context data 118, and the user security parameters 124. The user security parameters 124 and/or the user security levels 126 can be used to perform different service decisions, such as for services requested via the service applications 112.

The service security statuses 128 represent data that indicates different service attributes of service providers 104 that are available to provision services to the user 110 of the client device 102. Examples of the service security statuses 128 include service feedback data (e.g., user feedback associated with previous service provisions by the service providers 104), service cost (e.g., currency cost for service), service conditions (e.g., specific attributes of a service provider), etc.

The service providers 104 maintain and/or have access to the service security statuses 128, examples of which are described above. The service security statuses 128, for example, include service attributes of the different service providers 104. The network security service 106 represents a network service that can perform aspects of security parameter for a service request described herein. The network security service 106 maintains and/or has access to user context data 118, user security parameters 124, user security levels 126, and service security statuses 128, examples of which are described throughout this disclosure.

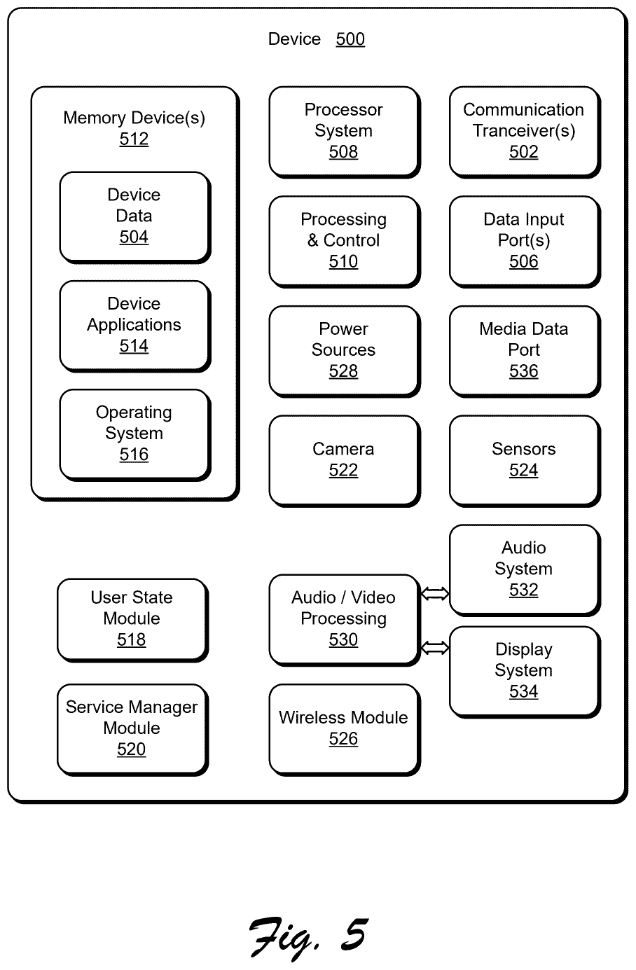

The client device 102 and the network security service 106 can be implemented in various ways and include various functionality, examples of which are discussed below with reference to the example device 500 of FIG. 5. Further, the network(s) 108 can represent a combination of wired and wireless networks via which the client device 102, the service providers 104, and the network security service 106 can participate in various types of communication, such as wired and/or wireless data communication.

Having discussed an example environment in which the disclosed techniques can be performed, consider now some example scenarios and implementation details for implementing the disclosed techniques.

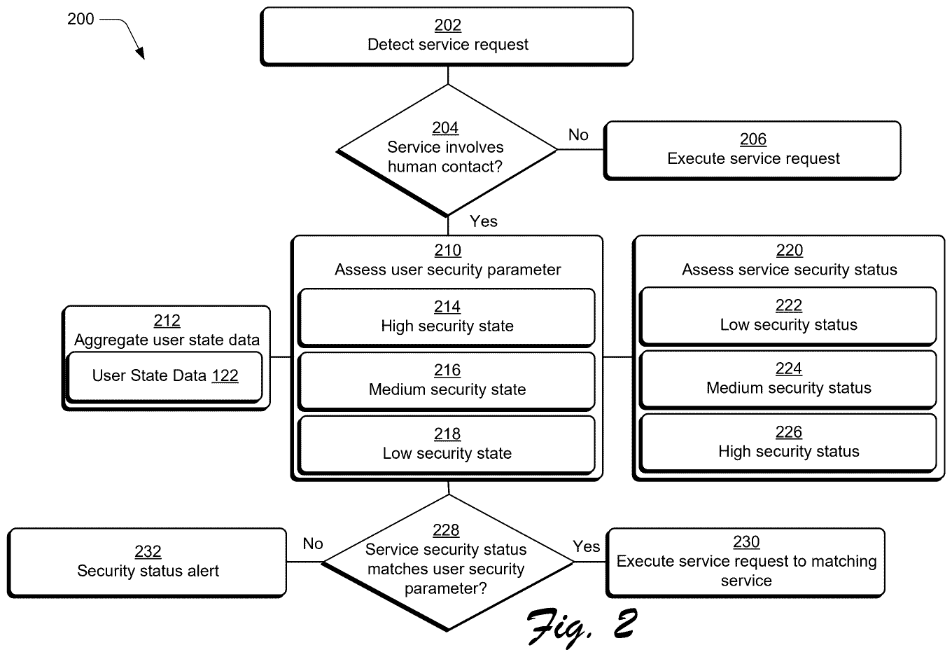

FIG. 2 illustrates an example flow chart for a process 200 in accordance with aspects of the present disclosure. Operations of the process 200, for instance, may be performed in the context of the environment 100, such as by the client device 102 and/or the network security service 106.

At 202, a service request is detected. The user 110, for example, interacts with a service application 112 to request a service. At 204, it is determined whether the requested service involves human contact. Service data for the requested service, for example, can indicate whether the requested service may involve or not involve physical proximity between the user 110 and another person associated with the requested service. If the requested service does not involve human contact (“No”), at 206 the service request is executed. The service request, for example, is transmitted and/or authorized to a service provider 104 that is indicated as capable of providing a service for the service request.

If the requested service involves human contact (“Yes”), at 210 a user security parameter is assessed. As part of the security parameter assessment, at 212 user state data is aggregated. The user state data, for example, can include user state data 122 generated via sensor data from the sensors 114. Examples of the user state data 122 include a current location of the user 110 (e.g., geographic and/or physical location), a proximity of the user 110 to one or more other client devices that are identified as trusted devices, a date and/or a time of the service request, a geographical location associated with the service request (e.g., where the service is to be initiated), etc.

Based on the user state data 122, the user security parameter assessment of 210 determines whether the user 110 is in a high security state 214, a medium security state 216, or a low security state 218. The high security state 214, for example, indicates that based on the user state data 122, the user 110 is in a highly secure context. Examples of user state data 122 that indicate that the user 110 is in a highly secure context include user proximity within a threshold distance of trusted users and/or trusted devices, user presence at a trusted location (e.g., a location indicated as “safe”), the service request occurring at a time of day indicated as “safe” (e.g., during daylight hours), etc. In implementations, the high security state 214 can be based on multiple overlapping instances of user state data 122 that indicate that the user 110 is in a highly secure state.

The medium security state 216 can be based on user state data 122 that indicates that the user 110 is in a security state that is less than the high security state 214. For example, one or more instances of the user state data 122 mentioned above with reference to the high security state 214 may apply, where other instances of the user state data 122 may not. For example, in the medium security state 216, the user state data 122 may indicate that the user 110 is positioned in a known trusted location but that the service request occurs at an untrusted time of day, e.g., late at night. As another example, in the medium security state 216, the user state data 122 may indicate that the user 110 is within a threshold distance of trusted users and/or trusted devices, but that the user 110 is positioned at an untrusted location, e.g., a location designated as untrusted and/or with an unknown security status.

The low security state 218 can be based on user state data 122 that indicates that the user 110 is in a security state that is less than the high security state 214 and the medium security state 216. For example, instances of the user state data 122 mentioned above with reference to the high security state 214 may not apply. Further, multiple instances of user state data 122 may indicate that the user 110 is in an unsecure state. For example, in the low security state 218, the user state data 122 may indicate that the user 110 is positioned at an unknown, untrusted, and/or unsafe location, the service request occurs at an untrusted time of day, the user 110 is not positioned within a threshold distance of trusted users and/or trusted devices, or combinations thereof.

Further to the process 200 and based on the security parameter assessment at 210, at 220 a service security status for different service providers 104 is assessed. The service security statuses include a low security status 222, a medium security status 224, and a high security status 226. The low security status 222 may be based on different factors such as a service provider 104 being associated with an unknown security state, a known low security status, poor user reviews (e.g., lower than average user ratings), known unsecure service attributes (e.g., service conditions that are known to be unsafe and/or that conflict with user preferences of the user 110), or combinations thereof.

The medium security status 224 may be a higher security status than the low security status 222 and can based on different factors, such as a service provider 104 having an unknown security state, being associated with average user reviews and/or user ratings, having known secure service attributes, or combinations thereof.

The high security status 226 may be a higher security status than the low security status 222 and the medium security status 224, and can based on different factors, such as a service provider 104 having known secure security state, being associated with highly favorable user reviews and/or ratings, having known secure service attributes (e.g., service conditions that are known to be safe and/or that comply with user preferences of the user 110), or combinations thereof.

In implementations, based on the user security parameter assessed at 210 and the service security statuses assessed at 220, at 228 it is determined whether a service security status for a service provider 104 matches the user security parameter. For instance, if the user 110 is in the high security state 214, a service provider 104 can be selected that complies with the low security status 222, the medium security status 224, or the high security status 226. If the user 110 is in the medium security state 216, a service provider 104 can be selected that complies with the medium security status 224 or the high security status 226. However, in the medium security state 216, service providers 104 that only comply with the low security status 222 may be omitted from consideration for fulfilling the service request.

In scenarios where the user 110 is in the low security state 218, service providers 104 that comply with the high security status 226 may be considered for fulfilling the service request, while service providers 104 that only comply with the medium security status 224 or the low security status 222 may be omitted from consideration for fulfilling the service request. If at 228 a service provider 104 is identified with a security status that matches the user security parameter (“Yes”), at 230 a service request is executed to the matching service provider 104. The service manager module 120, for example, causes a service request to be communicated (e.g., transmitted) by the client device 102 to the matching service provider 104.

If at 228 a service provider 104 is not identified with a security status that matches the user security parameter (“No”), at 232 a security status alert it output. The security status alert, for example, can be output via the client device 102 to notify the user 110 that a service provider 104 could not be identified that complies with a current security state of the user 110. In implementations, service providers 104 with a security status that does not comply with the user security parameter can be automatically rejected from consideration for fulfilling the service request.

Alternatively, or in addition, the security status alert can include an override option that enables the user 110 to provide input to cause the service request to be communicated to a service provider 104 with a service security status that does not comply with the user security parameter. For example, where the user 110 is in the low security state 218 but the service request is urgent in nature (e.g., the user needs transportation to the airport to board a flight), the user 110 may provide input to indicate that a service provider 104 with a medium security status 224 or a low security status 222 is acceptable to fulfill the service request.

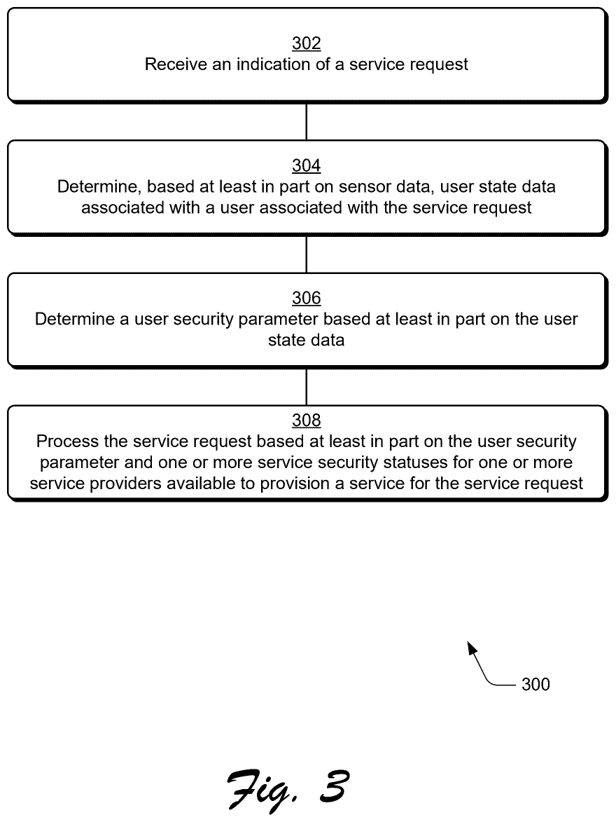

FIG. 3 illustrates a flow chart depicting an example method 300 for security parameter for a service request in accordance with one or more implementations. Operations of the method 300, for instance, may be performed in the context of the environment 100, such as by the client device 102 and/or the network security service 106.

At 302 an indication of a service request is received. A user, for example, interacts with a service application 112 to request a service. At 304, based at least in part on sensor data, user state data associated with a user associated with the service request is determined. Sensor data from the sensors 114, for example, is utilized to determine user state data. Examples of user state data are described throughout this disclosure.

At 306, a user security parameter is determined based at least in part on the user state data. The user security parameter, for example, can include a security state of the user. At 308, the service request is processed based at least in part on the user security parameter and one or more service security statuses for one or more service providers available to provision a service for the service request. The service manager module 120, for example, can determine whether a service provider 104 is available for the service request with a security status that matches (e.g., complies with) the user security parameter. In implementations, where a service provider 104 is available for the service request with a security status that matches the user security parameter, the service manager module 120 can cause the service request to be communicated to the service provider 104. If a service provider 104 is not available for the service request with a security status that matches the user security parameter, the service manager module 120 can reject the service request and/or can provide an override option that enables the user to communicate the service request to a service provider 104 that does not have a security status that matches the user security parameter.

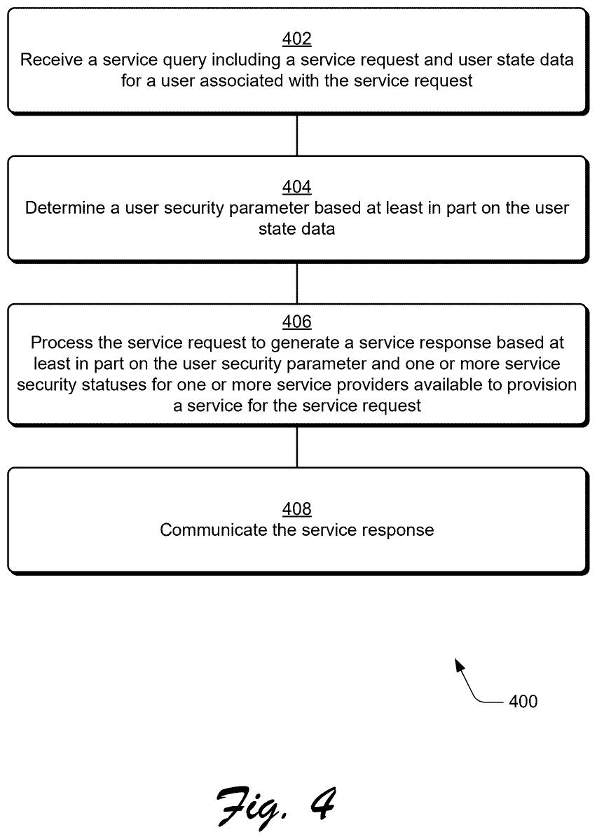

FIG. 4 illustrates a flow chart depicting an example method 400 for security parameter for a service request in accordance with one or more implementations. Operations of the method 400, for instance, may be performed in the context of the environment 100, such as by the network security service 106.

At 402, a service query is received including a service request and user state data for a user associated with the service request. The network security service 106, for example, receives an indication of a service query and user state data from the client device 102. In implementations, the user state data can include sensor data generated by the sensors 114.

At 404, a user security parameter is determined based at least in part on the user state data. For example, the network security service 106 can determine the user security parameter based at least in part on a security state of the user, e.g., a high security state, a medium security state, or a low security state.

At 406, the service request is processed to generate a service response based at least in part on the user security parameter and one or more service security statuses for one or more service providers available to provision a service for the service request. The network security service 106, for example, can attempt to match the user security parameter to a service security status for a service provider 104. Examples of matching user security parameters (e.g., user security states) to service security statuses are discussed throughout this disclosure.

At 408, the service response is communicated. For instance, the network security service 106 communicates (e.g., transmits) the service response indicating whether a service provider 104 with a security status that matches (e.g., complies with) the user security parameter is identified. In implementations, where a service provider 104 is identified with a security status that matches the user security parameter, the service response may identify the matching service provider 104. Alternatively, or in addition, the, the network security service 106 may communicate the service response to the matching service provider 104 to cause the service request to be executed by the service provider 104. If a service provider 104 with a security status that matches the user security parameter is not identified, the service response may indicate that no matching service provider 104 was identified.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 5 illustrates various components of an example device 500 in which aspects of security parameter for a service request can be implemented. The example device 500 can be implemented as any of the devices described with reference to the previous FIGS. 1-4, such as any type of mobile device, mobile phone, mobile device, wearable device, tablet, computing, communication, entertainment, gaming, media playback, and/or other type of electronic device. For example, the client device 102 and/or the network security service 106 as shown and described with reference to FIGS. 1-4 may be implemented as the example device 500.

The device 500 includes communication transceivers 502 that enable wired and/or wireless communication of device data 504 with other devices. The device data 504 can include one or more of device identifying data, device location data, wireless connectivity data, and wireless protocol data. Additionally, the device data 504 can include any type of audio, video, and/or image data. Example communication transceivers 502 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 500 may also include one or more data input ports 506 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 500 includes a processing system 508 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 510. The device 500 may further include any type of a system bus or other data and command transfer system that couples the various components within the device. A system bus can include any one or combination of different bus structures and architectures, as well as control and data lines.

The device 500 also includes computer-readable storage memory 512 (e.g., memory devices) that enable data storage, such as data storage devices that can be accessed by a computing device, and that provide persistent storage of data and executable instructions (e.g., software applications, programs, functions, and the like). Examples of the computer-readable storage memory 512 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 500 may also include a mass storage media device.

The computer-readable storage memory 512 provides data storage mechanisms to store the device data 504, other types of information and/or data, and various device applications 514 (e.g., software applications). For example, an operating system 516 can be maintained as software instructions with a memory device and executed by the processing system 508. The device applications may also include a device manager, such as any form of a control application, software application, signal-processing and control module, code that is native to a particular device, a hardware abstraction layer for a particular device, and so on. Computer-readable storage memory 512 represents media and/or devices that enable persistent and/or non-transitory storage of information in contrast to mere signal transmission, carrier waves, or signals per se. Computer-readable storage memory 512 do not include signals per se or transitory signals.

In this example, the device 500 includes a user state module 518 and a service manager module 520 that can implement aspects of security parameter for a service request and may be implemented with hardware components and/or in software. For example, the user state module 518 can be implemented as the user state module 116, and the service manager module 520 can be implemented as the service manager module 120, described in detail above. In implementations, the user state module 518 and/or the service manager module 520 may include independent processing, memory, and logic components as a computing and/or electronic device integrated with the device 500.

In this example, the example device 500 also includes a camera 522 and sensors 524. The sensors 524 can be implemented in various ways and are representative of functionality to detect various physical and/or logical phenomena in relation to the device 500, such as motion, light, image detection and recognition, time and date, position, location, touch detection, sound, temperature, and so forth. Examples of the sensors 524 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth.

The device 500 also includes a wireless module 526, which is representative of functionality to perform various wireless communication tasks. The device 500 can also include one or more power sources 528, such as when the device is implemented as a mobile device. The power sources 528 may include a charging and/or power system, and can be implemented as a flexible strip battery, a rechargeable battery, a charged super-capacitor, and/or any other type of active or passive power source.

The device 500 also includes an audio and/or video processing system 530 that generates audio data for an audio system 532 and/or generates display data for a display system 534. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 536. In implementations, the audio system and/or the display system are integrated components of the example device. Alternatively, the audio system and/or the display system are external, peripheral components to the example device.

Although implementations of security parameter for a service request have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one memory; and at least one processor coupled with the at least one memory and configured to, capable of, or operable to cause the client device to: receive an indication of a service request; determine, based at least in part on sensor data, user state data associated with a user associated with the service request; determine a user security parameter based at least in part on the user state data; and process the service request based at least in part on the user security parameter and one or more service security statuses for one or more service providers available to provision a service for the service request.

In some aspects, the techniques described herein relate to a client device, where the sensor data includes an indication of one or more of: a current location of the user associated with the service request; a proximity of the user associated with the service request to one or more other client devices that are identified as trusted devices; one or more of a date or a time associated with the service request; or a geographical location associated with the service request.

In some aspects, the techniques described herein relate to a client device, where the user security parameter is based at least in part on a set of user security parameters that are predefined for the user associated with the service request.

In some aspects, the techniques described herein relate to a client device, where each user security parameter of the set of user security parameters is associated with a different user security level of different user security levels.

In some aspects, the techniques described herein relate to a client device, where the different user security levels include: a first user security level that indicates that the user associated with the service request is in a high security state; a second user security level that indicates that the user associated with the service request is in a medium security state that is lower than the first user security level; and a third user security level that indicates that the user associated with the service request is in a low security state that is lower than the second user security level.

In some aspects, the techniques described herein relate to a client device, where the user security parameter is further determined based at least in part on user context data associated with the user.

In some aspects, the techniques described herein relate to a client device, where the user context data includes one or more of: feedback data for one or more previous service provisions associated with the user; user preference data; or service history data for one or more previous service provisions associated with the user.

In some aspects, the techniques described herein relate to a client device, where to determine the user security parameter, the at least one processor is configured to, capable of, or operable to cause the client device to: cause the sensor data and the user context data to be input to an artificial intelligence algorithm; and receive at least a portion of the user security parameter as output from the artificial intelligence algorithm.

In some aspects, the techniques described herein relate to a client device, where the at least one processor is configured to, capable of, or operable to cause the client device to: output, via the client device, a security parameter interface including one or more security parameter controls; receive an indication of interaction with the one or more security parameter controls; and determine the user security parameter based at least in part on the user state data and the interaction with the one or more security parameter controls.

In some aspects, the techniques described herein relate to a client device, where to process the service request, the at least one processor is configured to, capable of, or operable to cause the client device to compare the user security parameter to the one or more service security statuses to determine whether the one or more service security statuses meet the user security parameter.

In some aspects, the techniques described herein relate to a client device, where the at least one processor is configured to, capable of, or operable to cause the client device to: determine that a first service security status of the one or more service security statuses meets the user security parameter; and cause the service request to be transmitted to a first service provider of the one or more service providers associated with the first service security status.

In some aspects, the techniques described herein relate to a client device, where the at least one processor is configured to, capable of, or operable to cause the client device to: determine that a second service security status of the one or more service security statuses does not meet the user security parameter; and cause a service rejection of the service request for a second service provider of the one or more service providers associated with the second service security status.

In some aspects, the techniques described herein relate to a client device, where the at least one processor is configured to, capable of, or operable to cause the client device to: output, via the client device, a notification of the service rejection of the service request for the second service provider.

In some aspects, the techniques described herein relate to a client device, where the notification of the service rejection includes a rejection override control, and where the at least one processor is configured to, capable of, or operable to cause the client device to: receive an indication of a selection of the rejection override control; and cause, based at least in part on the selection of the rejection override control, the service request to be transmitted to the second service provider.

In some aspects, the techniques described herein relate to a method performed by a client device, the method including: receiving an indication of a service request; determining, based at least in part on sensor data, user state data associated with a user associated with the service request; determining a user security parameter based at least in part on the user state data; and processing the service request based at least in part on the user security parameter and one or more service security statuses for one or more service providers available to provision a service for the service request.

In some aspects, the techniques described herein relate to a system including: at least one memory; and at least one processor coupled to the at least one memory and configured to, capable of, or operable to cause the system to: receive a service query including a service request and user state data for a user associated with the service request; determine a user security parameter based at least in part on the user state data; process the service request to generate a service response based at least in part on the user security parameter and one or more service security statuses for one or more service providers available to provision a service for the service request; and communicate the service response.

In some aspects, the techniques described herein relate to a system, where the user security parameter is based at least in part on a set of user security parameters that are predefined for the user associated with the service request.

In some aspects, the techniques described herein relate to a system, where each user security parameter of the set of user security parameters is associated with a different user security level of different user security levels, and where the different user security levels include: a first user security level that indicates that the user associated with the service request is in a high security state; a second user security level that indicates that the user associated with the service request is in a medium security state that is lower than the first user security level; and a third user security level that indicates that the user associated with the service request is in a low security state that is lower than the second user security level.

In some aspects, the techniques described herein relate to a system, where to process the service request, the at least one processor is configured to, capable of, or operable to cause the system to compare the user security parameter to the one or more service security statuses to determine whether the one or more service security statuses meet the user security parameter.

In some aspects, the techniques described herein relate to a system, where the at least one processor is configured to, capable of, or operable to cause the system to: cause the service request to be transmitted to a first service provider of the one or more service providers based at least in part on a security status of the first service provider meeting the user security parameter; and cause a service rejection of the service request for a second service provider of the one or more service providers based at least in part on a security status of the second service provider not meeting the user security parameter.

What is claimed is:

1. A client device comprising:
at least one memory; and
at least one processor coupled with the at least one memory and operable to cause the client device to:
receive an indication of a service request;
determine, based at least in part on sensor data, user state data associated with a user associated with the service request;
determine a user security parameter based at least in part on the user state data; and
process the service request based at least in part on the user security parameter and one or more service security statuses for one or more service providers available to provision a service for the service request.

2. The client device of claim 1, wherein the sensor data comprises an indication of one or more of:
a current location of the user associated with the service request;
a proximity of the user associated with the service request to one or more other client devices that are identified as trusted devices;
one or more of a date or a time associated with the service request; or
a geographical location associated with the service request.

3. The client device of claim 1, wherein the user security parameter is based at least in part on a set of user security parameters that are predefined for the user associated with the service request.

4. The client device of claim 3, wherein each user security parameter of the set of user security parameters is associated with a different user security level of different user security levels.

5. The client device of claim 4, wherein the different user security levels comprise:
a first user security level that indicates that the user associated with the service request is in a high security state;
a second user security level that indicates that the user associated with the service request is in a medium security state that is lower than the first user security level; and
a third user security level that indicates that the user associated with the service request is in a low security state that is lower than the second user security level.

6. The client device of claim 1, wherein the user security parameter is further determined based at least in part on user context data associated with the user.

7. The client device of claim 6, wherein the user context data comprises one or more of:
feedback data for one or more previous service provisions associated with the user;
user preference data; or
service history data for one or more previous service provisions associated with the user.

8. The client device of claim 7, wherein to determine the user security parameter, the at least one processor is operable to cause the client device to:
cause the sensor data and the user context data to be input to an artificial intelligence algorithm; and
receive at least a portion of the user security parameter as output from the artificial intelligence algorithm.

9. The client device of claim 1, wherein the at least one processor is operable to cause the client device to:
output, via the client device, a security parameter interface comprising one or more security parameter controls;
receive an indication of interaction with the one or more security parameter controls; and
determine the user security parameter based at least in part on the user state data and the interaction with the one or more security parameter controls.

10. The client device of claim 1, wherein to process the service request, the at least one processor is operable to cause the client device to compare the user security parameter to the one or more service security statuses to determine whether the one or more service security statuses meet the user security parameter.

11. The client device of claim 10, wherein the at least one processor is operable to cause the client device to:
determine that a first service security status of the one or more service security statuses meets the user security parameter; and
cause the service request to be transmitted to a first service provider of the one or more service providers associated with the first service security status.

12. The client device of claim 10, wherein the at least one processor is operable to cause the client device to:
determine that a second service security status of the one or more service security statuses does not meet the user security parameter; and
cause a service rejection of the service request for a second service provider of the one or more service providers associated with the second service security status.

13. The client device of claim 12, wherein the at least one processor is operable to cause the client device to:
output, via the client device, a notification of the service rejection of the service request for the second service provider.

14. The client device of claim 13, wherein the notification of the service rejection comprises a rejection override control, and wherein the at least one processor is operable to cause the client device to:
receive an indication of a selection of the rejection override control; and
cause, based at least in part on the selection of the rejection override control, the service request to be transmitted to the second service provider.

15. A method performed by a client device, the method comprising:
receiving an indication of a service request;
determining, based at least in part on sensor data, user state data associated with a user associated with the service request;
determining a user security parameter based at least in part on the user state data; and
processing the service request based at least in part on the user security parameter and one or more service security statuses for one or more service providers available to provision a service for the service request.

16. A system comprising:
at least one memory; and
at least one processor coupled to the at least one memory and operable to cause the system to:
receive a service query comprising a service request and user state data for a user associated with the service request;
determine a user security parameter based at least in part on the user state data;
process the service request to generate a service response based at least in part on the user security parameter and one or more service security statuses for one or more service providers available to provision a service for the service request; and
communicate the service response.

17. The system of claim 16, wherein the user security parameter is based at least in part on a set of user security parameters that are predefined for the user associated with the service request.

18. The system of claim 17, wherein each user security parameter of the set of user security parameters is associated with a different user security level of different user security levels, and wherein the different user security levels comprise:
a first user security level that indicates that the user associated with the service request is in a high security state;
a second user security level that indicates that the user associated with the service request is in a medium security state that is lower than the first user security level; and
a third user security level that indicates that the user associated with the service request is in a low security state that is lower than the second user security level.

19. The system of claim 16, wherein to process the service request, the at least one processor is operable to cause the system to compare the user security parameter to the one or more service security statuses to determine whether the one or more service security statuses meet the user security parameter.

20. The system of claim 16, wherein the at least one processor is operable to cause the system to:
cause the service request to be transmitted to a first service provider of the one or more service providers based at least in part on a security status of the first service provider meeting the user security parameter; and
cause a service rejection of the service request for a second service provider of the one or more service providers based at least in part on a security status of the second service provider not meeting the user security parameter.
